(19) United States
(12) Patent Application Publication
(10) Pub. No.: US 2013/0330704 A1
(43) Pub. Date: Dec. 12, 2013

(54) STUDENT INFORMATION SYSTEM

(71) Applicant: American Virtual Academy, Chandler, AZ (US)

(72) Inventors: Damian Creamer, Chandler, AZ (US); Michael Graf, Chandler, AZ (US); Curtis Despain, Chandler, AZ (US); Skyler Todd, Chandler, AZ (US); Tiffiny Scott, Chandler, AZ (US); Alex Bowen, Chandler, AZ (US)

(21) Appl. No.: 13/916,362

(22) Filed: Jun. 12, 2013

Related U.S. Application Data
(60) Provisional application No. 61/658,770, filed on Jun. 12, 2012.

(51) Int. Cl. G09B 7/00

(52) U.S. Cl. CPC G09B 7/00
USPC 434/362

(57) ABSTRACT

In various embodiments, a method for providing online education is disclosed. The method may comprise receiving first data via a first user interface (“UI”) comprising a parent student portal (“PSP”), receiving second data via a second user interface (“UI”) comprising a learning management system (“LMS”), receiving third data via a third user interface (“UI”) comprising a student information system (“SIS”), and/or storing the first data, the second data, and the third data to a central data repository (“CDR”). In various embodiments, the method may further comprise enabling customization of at least one of the first UI, the second UI, and the third UI by an education provider. Further still, the method may comprise filtering data based upon a filter criterion, and/or communicating a notification to a plurality of users based upon the filtering.

### CROSS-REFERENCE TO RELATED APPLICATIONS

This application is a non-provisional of and claims priority to and the benefit of U.S. provisional patent application Ser. No. 61/658,770, entitled “STUDENT INFORMATION SYSTEM,” and filed on Jun. 12, 2012, which is incorporated by reference herein in its entirety.

### BACKGROUND

1. Field

The present disclosure generally relates to online education systems, and more particularly to integrated online education systems.

2. Discussion of Related Art

Online education continues to be a growing industry that fosters innovation and competition among service providers. In this competitive world of online education, implementing a quality e-learning program typically presents a number of unique challenges and risks; both logistically and financially. Any education or training service provider (e.g. a school, university or industry association) must analyze and balance curriculum standards and compliancy requirements, information technology resources and the administrative and human resources necessary to effectively develop, deploy, operate and maintain a viable online educational offering. Furthermore, in this increasingly busy world, students need to access information to better manage the demands on their time. For instance, with more students living in non-traditional family settings (e.g., single-parent, armed service, work abroad, farming, and other scenarios), accessing a fully-online curriculum provides students the flexibility to access their classes anytime; from anywhere they have access to the Internet without sacrificing the quality of their education.

To address the demand for online education services, companies have developed solutions aimed at providing the software and services necessary to support the various aspects of online education. A typical student information system (SIS) includes a set of interfaces that enable interaction with the student. Through web-based user interfaces (UIs), students are able to register, pay, access content (e.g. class lectures and materials) and review their performance. Furthermore, UIs often allow parents or other authorized individuals a view of a student's progress and performance.

Current SISs may both automated and manual processes and may not store data in a central location. In addition, conventional systems may not be customizable by an education provider. Rather, customization may require the intervention of a third party software developer, which may take quite some time to accomplish. It would be advantageous to provide an SIS that enables any participant (e.g., student, school, administrator, etc.) in the online learning process to customize the data of the system (e.g., student attributes, enrollment parameters, school characteristics, curriculum requirements, etc.). It would also be advantageous to provide a SIS in which data is stored in a central location, such that the SIS might function as a single education source or a “one stop shop” for student education. Therefore, a long felt need exists for a comprehensive, integrated, configurable, customizable and extensible student information system.

### SUMMARY

In various embodiments, a method for providing online education is disclosed. The method may comprise receiving first data via a first user interface (“UI”) comprising a parent student portal (“PSP”), receiving second data via a second user interface (“UI”) comprising a learning management system (“LMS”), receiving third data via a third user interface (“UI”) comprising a student information system (“SIS”), and/or storing the first data, the second data, and the third data to a central data repository (“CDR”). In various embodiments, the method may further comprise enabling customization of at least one of the first UI, the second UI, and the third UI by an education provider. Further still, the method may comprise filtering data based upon a filter criterion, and/or communicating a notification to a plurality of users based upon the filtering.

In various embodiments, the method may also comprise tracking the online activity of a user, and/or determining an optimal time to contact the user. In addition, the method may include tracking a grade point average of a user, and/or communicating a notification in response to the tracking. The method may also comprise enabling functionality whereby a substitute teacher impersonates and is provided access to the account of another teacher, and/or flagging changes effected by the substitute teacher. In various embodiments, the method may comprise automatically requesting student records from at least one of a brick and mortal education provider or an online education provider. The third UI may comprise a general summary portion and a detailed summary portion, where the general summary portion is capable of being minimized. In certain embodiments, the method may further comprise calculating, in advance of completion of an assignment, the impact that completion of the assignment will have upon an overall grade of a student, and/or calculating, in advance of non-completion of an assignment, the impact that non-completion of the assignment will have upon an overall grade of a student.

In various embodiments, the method may, in addition, comprise calculating a grade of a student based upon a proportion of a number of assignments that a student has been assigned to complete by a particular time to a number of assignments that the student has actually completed by the particular time. Further, the method may comprise enabling the addition of a resource by an instructor to a content dialog box displayed by the second UI, and/or displaying in juxtaposition, within the second UI, an instructions dialog box, a content dialog box, and a workbook dialog box. A student may complete an assignment in the workbook dialog box. The method may also include associating at least one of a temporary alert with a student and a permanent flag with a student, displaying, within the third UI, information associated with an instructor, and/or displaying, within the third UI, information associated with a student.

### BRIEF DESCRIPTION OF THE DRAWINGS

This disclosure will hereinafter be described in conjunction with the appended drawing figures, wherein like numerals denote like elements, and wherein;

FIG. 1 is a block diagram depicting various system components for a virtual school system, in accordance with various embodiments; and

FIG. 2 is an interface diagram showing a learning models smart form, in accordance with various embodiments;

FIG. 3 is an interface diagram showing a federal/state changes form, in accordance with various embodiments;

FIG. 4 is an interface diagram showing an analytical dashboard, in accordance with various embodiments;

FIG. 5 is an interface diagram showing a welcome page for a parent student portal;

FIG. 6 is an interface diagram showing a home page of a parent student portal;

FIG. 7 is an interface diagram showing a learning management interface.

FIG. 8 is an interface diagram showing a student information management system dashboard interface.

FIG. 9 is an interface diagram showing a student information management system a student roster.

### DETAILED DESCRIPTION OF THE ILLUSTRATED EMBODIMENTS

This application incorporates by reference, in its entirety, U.S. patent application Ser. No. 12/359,930 entitled “System and Method for a Virtual School,” filed on Jan. 26, 2009.

The detailed description of exemplary embodiments of the invention herein makes reference to the accompanying drawings, which show embodiments by way of illustration and best mode. While these embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention provides systems and methods to define, automate and implement processes and tools for an SIS. In one embodiment, a system comprises numerous interconnected applications and software subsystems that are configured for the total enablement of an online, integrated, comprehensive SIS. In various embodiments, a SIS may comprise all and/or a part of a virtual school, as described in U.S. patent application Ser. No. 12/359,930, entitled SYSTEM AND METHOD FOR A VIRTUAL SCHOOL, which is hereby incorporated by reference in its entirety.

In one embodiment, a SIS provides dynamic, customizable user interfaces, data processing functions, process definition, rule definition and rule evaluation capabilities, workflow functionality, interoperability with existing educational and government systems and processes, and planning, reporting, audit and compliance functions. The SIS further includes a workflow engine to define processes, evaluate predefined rules and automate workflow, and a central data repository to store, manage, track and integrate comprehensive data for the SIS and related systems.

The SIS provides relevant content and rich functionality to users through dynamic and customizable user interfaces. In various embodiments, the SIS enables configuration, tracking and rich functionality for a variety of online education related entities, such as: a school, employees, students, classes, class rooms and online accounts. In various embodiments, user interfaces and usability features include smart forms, learning models, probability analysis, data validation and confirmation, analytical dashboards, intuitive design.

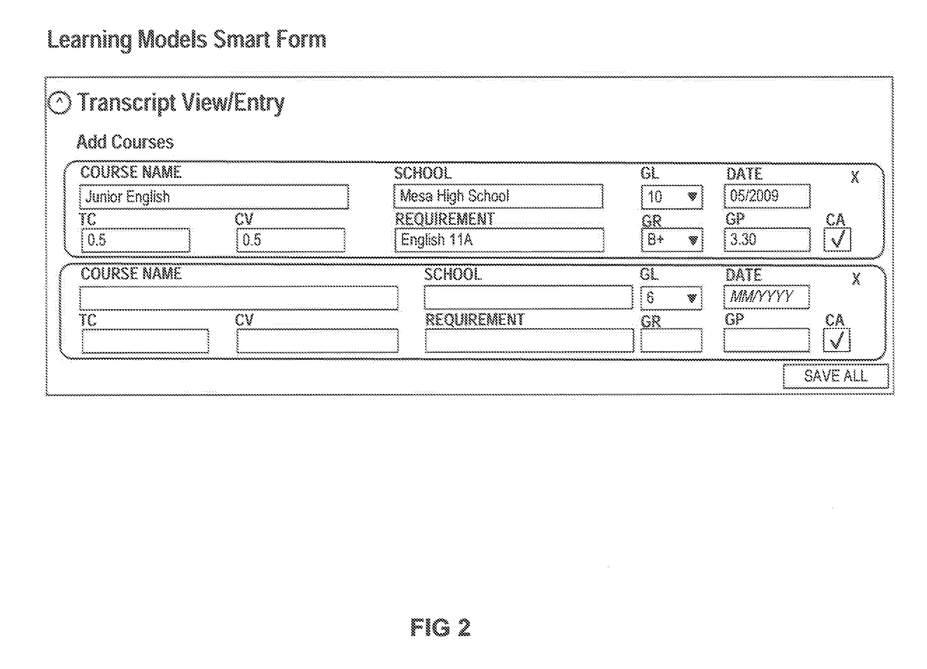

Smart forms are filled out semi-automatically, in the appropriate places, with data that is based on previous data that was entered. Algorithms are used to determine the probability of most likely the user is trying to type in or what data that person is looking for and automatically populating or selecting that data creating efficient and effective process and a more easily useable system. FIG. 2 shows an example of a smart form for learning models.

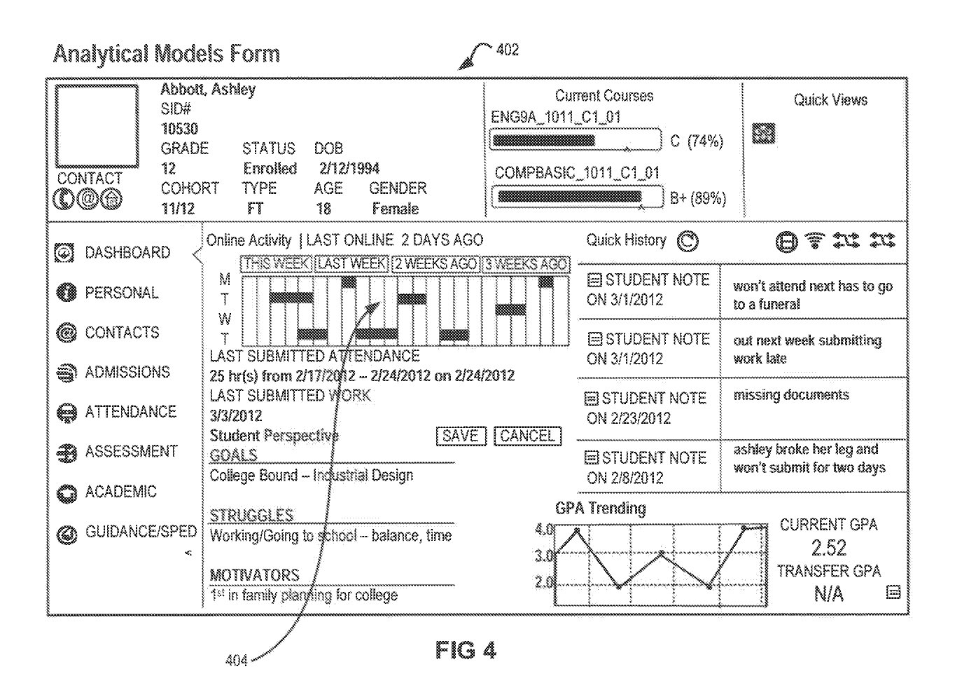

Analytical Dashboards are for different roles and entities in the system that better help and understand the students, instructors, employees, schools, districts, courses, student courses, etc. and perform predictive and forecasting algorithms to predetermine what track (or how well or other) a particular entity is doing to help make decisions that help or guide it. FIG. 4 is an analytical models form (“dashboard”) for a student. Thus, in various embodiments, a user may be granted and/or denied access to any of the system 100 components (e.g., the SIS 115, the PSP 195, the LMS 185, etc.) based upon one or more roles assigned to the user.

SIS features may include, for example, family management, notifications, smart phone integration (e.g., apps), student flags, and note tracking on students, diploma builder, granular security/roles, student property groups and enrollment app customization.

In an embodiment, student flags are a derived flags (something marked for attention or treatment or just as informational) based on data in the system. Student flags may be customizable per school depending on how the school wishes to flag a student and what they want it to say based on whatever data they would like.

In an embodiment, a family management includes the ability to tightly and loosely couple students to other family members (siblings, parents/guardians, relatives, or other people that can be loosely associated like neighbors, etc.).

In an embodiment, notifications enable notification of any entity in the system (parents, teachers, administrators, etc.) based on a set of data that changes. This could be based upon grade changes, grading, class changes, communication between entities, attendance, etc. The notifications can be sent to smart phones, email, text message, application alert, internal messaging system, etc.

In an embodiment a security/roles feature enables the ability to configure and govern what an entity in the system is authorized to view, change, add or delete. Roles are created to encompass a group of authorizations and an entity can be assigned multiple roles to establish a different range or security.

In an embodiment, a diploma builder enables a user to create different diplomas (e.g., for a single school) in the system based on credit(s), required course(s), or the combination. The diploma builder includes the ability to do and/or logic in determining what the student needs to accomplish to qualify for a diploma. Thus, the diploma builder may enable the creation, by any of the modules comprising system 100, of a customized diploma.

In various embodiments, student properties are extended, trackable, changeable, configurable data points that can be assigned to students and are created at a school level by school administrators. These data points can be assigned, changed, validated, reported on, etc. In various embodiments, student property groups are a collection of student properties used for an organization. A student property is immediately available to the administrators of the system.

In various embodiments, enrollment application customization enables the online enrollment that is customizable and enables collection of whatever information the school desires, in whatever order they would like to collect it in. The school has the ability to select whatever data points exist for students and also select from all the student properties and/or property groups.

In various embodiments, the SIS may interface with and/or include: a student management module (“SMM”) for managing a plurality of students; a student self-management module (“SS-MM”) for enabling customization of attributes, preferences, parameters, etc.; a learning management system (“LMS”) for managing and delivering the content of a plurality of online courses; and, a school administration module (“SAM”) for managing the administrative functions of at least one virtual school; a parent management module (PMM) which allows the parent to manage alerts, customization of attributes, preferences, parameters, communicate to faculty, etc.

In one embodiment, a system and/or method allows students to completely enroll online. According to this embodiment, the SIS is configured to allow faculty and staff at an online educational institution to properly admit students, provide them necessary guidance counseling and various other instructions. In an embodiment, UIs provide parents and students access to an LMS and numerous other portals and databases such as a client database and a standardized testing database.

In one embodiment, the system comprises a software based SIS in communication with a LMS. The SIS may be configured to enable an online educational system provider to manage its student body. Further, according to another embodiment, the SIS is configured to enable staff members to contact and follow up with one another to ensure that all students' needs are adequately met. According to one embodiment, the SIS further comprises a parent/student portal. According to various embodiments, the system of the present invention further comprises an application portal that enables student to apply for admission into an online educational program.

In one embodiment, the system includes a user interface (UI), a software module, logic engines, numerous databases and computer networks. While the system may contemplate upgrades or reconfigurations of existing processing systems, changes to existing databases and business information system tools are not necessarily required by the present invention.

The benefits provided by this invention include, for example, increased quality of service, increased functionality, increased efficiency, cost savings and increased integration with government, regulatory and educational systems. For the student, the system provides a more seamless, easy-to-use, intuitive educational environment. This environment helps students to achieve their educational goals easier and faster. The integrated environment prevents duplicate entry of information and the need to access multiple systems to complete education requirements. For example, the system allows a student, from a single interface, to apply for admissions, plan their course of study, register for courses, receive guidance, make payments, receive course instruction, view course content, participate in online discussions, complete assessments (e.g., exams, quizzes, etc.), review current and past performance, coordinate meetings with instructors, parents and administrators, and sign up for standardized tests. Thus, the student benefits from time saving features, richer education delivery mechanisms, such as a discussion interface, and integrated functions to provide support services such as guidance counseling and parental participation functions.

The education provider benefits from fewer manual processes, increased integration of automated systems, the ability to efficiently manage students, staff and resources and efficient reporting, compliance and audit capabilities. The system enables the education provider automate a comprehensive set of school functions, from planning to instruction to compliance with government rules and standards. The integrated student management interface allows administrators to assign and track resources, guidance staff to manage student interactions and instructors to plan and manage classes. The central data repository integrates the data into a universal data model that allows for more accurate information and that reduces duplicate entry. The system is configured with predefined reports that any school can use. In an embodiment, data in the central data repository is configured into logical cubes and enables any entity (e.g., school) to parse, aggregate, filter, view, report on, etc. This gives schools, districts, teachers, administrators or any other user of the system the ability to view the precise data that they wish, at the desired level of granularity or summarization, and when they want.

The workflow and rules engine capabilities allow the education provider to set up and automate a school's processes and automatically track and assign tasks to various staff members. Such functionality enables complete self-reliance by allowing entities (e.g., schools) to be able to make modifications to, for example, their processes, workflows, tasking, configurations, settings, diplomas, calendars, permissions, roles, enrollment apps, student data points, departments/workgroups, how household contacting information works, certifications, endorsements, awards, credentials, certifications, teaching roles, and etc. A user friendly interface enables entities complete control of how all the features and functions work. For example, drag and drop functions are defined by clicking on a UI element on the screen and holding down until you know where you want to place that UI element in concert with the interface.

Briefly, while the description references specific technologies, system architectures and data management techniques, practitioners will appreciate that this description is but one embodiment and that other devices and/or methods may be implemented without departing from the scope of the invention. Similarly, while the description references a user interfacing with the system via a personal computer user interface, practitioners will appreciate that other interfaces may include mobile devices, kiosks and handheld devices such as personal digital assistants.

“Entity” may include any individual, consumer, customer, group, business, organization, government entity, software, hardware, and/or any other entity.

“Online educational system provider” or “education provider” or “school” includes any entity that provides educational courses, whether those courses are part of an accredited education curriculum or not, such as online primary or high schools, colleges or universities, institutions providing courses for a particular profession (such as continuing legal education courses for attorneys) or any individual or entity providing courses that are capable of being taught online either now or in the future.

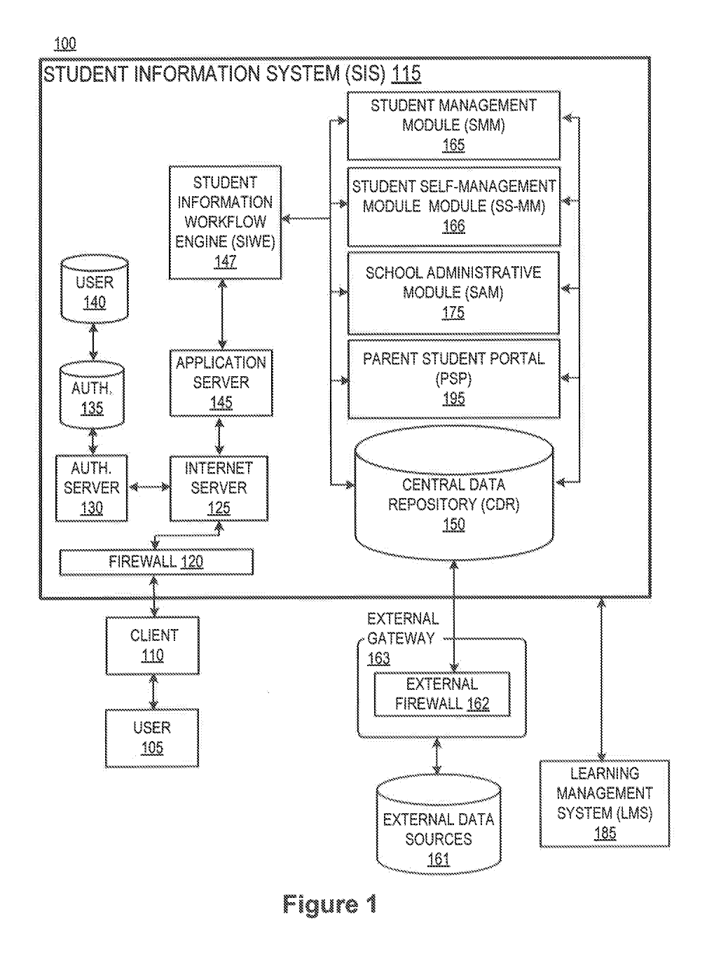

A “user” may include any individual or entity that interacts with a system or participates in a process. With reference to FIG. 1, user 105 may perform tasks such as requesting, retrieving, receiving, updating, analyzing, entering and/or modifying data. User 105 may interface with Internet server 125 via any communication protocol, device or method discussed herein, known in the art, or later developed. User 105 may be, for example, a student, a parent (or any user responsible for a student), faculty or staff, such as a teacher, an instructor, a teaching assistant, an enrollment/admissions staff, student services staff, such as a student mentor/advisor, a guidance counselor, an academic counselor, a special education service coordinator, an English language learner service coordinator, etc. In one embodiment, users are assigned to roles that are used to determine user permissions or default user interfaces. For instance, a user 105 may be assigned to a faculty role and the user interfaces may be tailored to present data and provide functions relevant to a faculty member.

In one embodiment, with reference to FIG. 1, system 100 includes a user 105 interfacing with a SIS 115 by way of a client 110. Client 110 comprises any hardware and/or software suitably configured to facilitate requesting, retrieving, updating, analyzing, entering and/or modifying data. The data may include verification data, authentication data, instructional data, demographic data, testing data, transaction data, performance and reporting data or any information discussed herein. Client 110 includes any device (e.g., personal computer), which communicates (in any manner discussed herein) with the SIS 115 via any network discussed herein. Browser applications comprise Internet browsing software installed within a computing unit or system to conduct online communications and transactions. These computing units or systems may take the form of personal computers, mobile phones, personal digital assistants, mobile email devices, laptops, notebooks, hand held computers, portable computers, kiosks, and/or the like. Practitioners will appreciate that the client 110 may or may not be in direct contact with the SIS 115. For example, the client 110 may access the services of the SIS 115 through another server, which may have a direct or indirect connection to Internet server 125.

User 105 may communicate with the SIS 115 through a firewall 120 to help ensure the integrity of the SIS 115 components. Internet server 125 may include any hardware and/or software suitably configured to facilitate communications between the client 110 and one or more SIS 115 components.

Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within authentication database 135 and user database 140. Application server 145 may include any hardware and/or software suitably configured to serve applications and data to a connected client 110.

In various embodiments, SIS 115 is used to customize, manage and completely integrate student information in an online or other computer-based educational environment. SIS 115 is a fully integrated system comprised of various subsystems, modules and databases. With reference again to FIG. 1, SIS 115 combines and allows communication between SMM 165, SS-MM 166, SAM 175, LMS 185, PSP 195, various other portals and UIs (not shown in FIG. 1), central data repository (“CDR”) 150 and external data sources 161. In one embodiment, UIs are accessed via a web portal and the elements of the UI may be comprised of movable, resizable web parts. These components are interconnected and communicate with one another to allow for a completely integrated online educational institution that allows parents, students, instructors, administrators, regulators, auditors, government officials and other educators to plan and monitor all the activities and operations of a educational institution.

Student information workflow engine (“SIWE”) 147 is a software module configured to enable online functions such as receiving query requests, configuring responses, dynamically configuring user interfaces, requesting data, receiving data, prompting user 105 with security challenges, verifying user responses, authenticating the user, initiating SIS 115 processes, initiating other software modules, encrypting and decrypting. Additionally, SIS 115 may include any hardware and/or software suitably configured to receive requests from client 110 via Internet server 125 and the application server 145. SIS 115 is further configured to process requests, execute transactions, construct database queries, and/or execute queries against databases, within system 100 (e.g., central data repository (“CDR”) 150), external data sources 161 and temporary databases.

SIS 115 is configured to exchange data with other systems and application modules such as SMM 165, SAM 175, LMS 185, and PSP 195. In one embodiment, the SIS 115 may be configured to interact with other system 100 components to perform complex calculations, retrieve additional data, format data into reports, create XML representations of data, construct markup language documents, construct, define or control UIs, and/or the like. Moreover, SIS 115 may reside as a standalone system or may be incorporated with the application server 145 or any other SIS 115 component as program code. As one of ordinary skill in the art will appreciate, SIS 115 may be logically or physically divided into various subcomponents such as a workflow engine configured to evaluate predefined rules and to automate processes associated with SIS 115. In one embodiment, SIS 115 is configured to automate, track, route, status and manage tasks, messages and events associated with other SIS 115 subsystems and integrated online education services and processes.

SMM 165 is a software subsystem and integrated component of SIS 115 that allows students to manage their online education experience and enables staff to manage and track students enrolled in classes, or otherwise accessing educational content or instruction, provided by an online educational system provider. SMM 165 is comprised of multiple software applications and/or computer modules which are configured to automate a plurality of student management functions including admissions, student registration, student self-management, course registration, course planning, student counseling, course scheduling, performance tracking, attendance tracking, and assessment reporting. Enrolled students (as well as potential students) and their progress are managed by SMM 165. In one embodiment, course management includes enforcing course content requirements that may be mandated by, for example, an accreditation authority, a school board, a school district, a state government, the federal government, or an education industry standard.

In various embodiments, SMM 165 provides functionality for various entities. For example, functionality enabled by SMM 165 for a school includes: configure the diploma type, define an enrollment process, create custom reports, implement counseling and guidance processes, configure online security, define and integrate a course catalog, define and maintain a school calendar and enable registration and payment functions. Custom reports are available to allow the user to decide on what information they would like to report on—historically, current, with the options of creating filters and the complete ability to select what data points they would like to see grouped, aggregated and other.

In various embodiments, school calendar allows an entity, such as a school, to create a calendar that has several properties that allow it to be displayed (or not displayed) to students, staff, parents or other entities via SIS, LMS, Portals, mobile device or other interfaces. Some examples of properties that can be displayed include events, holidays, when semesters or blocks start, birthdays, etc.

Functionality enabled by SMM 165 related to an employee (e.g., faculty, administrator, etc.) includes, for example: certification and qualifications processes and tracking, entering and maintaining fingerprinting and other security data, directory functions, roles, scheduling, endorsements, preferences, tasks, and the like. In an embodiment, employee data is tracked and kept according to customizable configuration that is set, for example, to what is necessary to run a school or schooling business. In various embodiments qualifications, certifications, fingerprints, security data and endorsements can all be set by the district, school, state or nation to meet a certain standard before being allowed to do certain functions in a school. SIS 115 allows for these to be customizable to whatever is necessary for what the school or district would like to do.

Functionality enabled by SMM 165 for a student includes, for example: curriculum and graduation tracking and progress reporting, contact information, relationships (e.g. family) to other users, transcripts, attendance, special education information, note tracking, action history and messaging. In various embodiments, SIS 115 provides full functionality to track all contact information to a student include contact information for family members and other relationships. Transcript entry, tracking and evaluation are also built into the system. Attendance is a configurable feature that schools can turn off or on and have a multitude of configurations that can be set around the collection, evaluation and reporting. Special education information is tracked per student is different types can be configured by the school. Note tracking and action history can be combined to fully track when an action has been taken on a student (any kind of change of data to that student) to track why it was done by the person who did it. Messaging is an internal messaging (e.g. email) system that is fully integrated in SIS 115 and can be reported against, etc.

Functionality enabled by SMM 165 for a class and/or a class room includes, for example: scheduling, grading, content delivery, and the like. In various embodiments, scheduling includes the processing of scheduling courses to a student that are needed in order to accomplish a specific goal like a diploma, certification or other. Grading is the process of evaluating assessments done to the student and providing grades. Content delivery is part of the LMS to give the learning materials to the student.

Account management (AM) functionality enabled by SMM 165 includes, for example: feature control, school control, billing, accounting, and the like. In various embodiments, account management functions enable an entity (such as the owner) to control what features schools/districts/companies/etc. have access to. What access AMs have to schools and to control, view, report and other billing and accounting information may be defined during the process of creating the contract with the client.

In various embodiments, a SS-MM 166 enables a student (i.e., a user 105 of SIS 115) to customize his/her parameters, attributes, preferences, and the like. For example, in an embodiment SS-MM 166 enables a student to configure administrative information such as enrollment type, diploma type, etc. and also enables the student to configure other attributes such as the student's eye color, hair color, hobbies, etc. Such customization by a user of SIS 115 data may be implemented at any organizational level. For example, SIS 115 may serve as a student information system for many online schools. Thus, user customization may take effect globally (across all the entire system), at the school level, at the class level, or at any other logical level or grouping that the user may be associated with. In various embodiments, SS-MM 166 may be integrated with SMM 165 or other modules or may be a stand alone module or application.

SMM 165 further comprises various UIs for staff members to access. Any number of staff members can access SMM 165 and a staff member can have greater access to student records than other staff members depending on the particular staff member's need. Staff members that access SMM 165 include admissions staff, guidance counselors, administrators, teachers, professors, and other instructors.

SAM 175 is a software subsystem and integrated component of SIS 115 that enables user 105 (e.g., a school administrator) to manage the administrative functions of a school. In one embodiment, SAM 175 includes a tasking module, a budgeting module, a finance module, a resource management module, an operational performance tracking and reporting module, a regulatory module and a compliance reporting module. In various embodiments, the tasking module allows tasks to be entered, assigned, tracked, reported upon, etc.

The tasking module enables both manual and automatic task entry. For example, an employee (e.g., principal) may enter a task to a teacher to have her grades entered by a certain date and/or SAM 117, in conjunction with SIWE 147 and SAM 175, may automatically assign a task based upon information in CDR 150; for example, in an embodiment the tasking module of SAM 175 reads CDR 150 data indicating the end of a semester, determines the classes taught by a particular instructor and automatically generates a task (or a plurality of tasks) for the instructor to enter grades into SMM 165. In various embodiments, a tasking module allows a user 105 to view their own tasks, assign tasks, reassign tasks, update tasks, send a status report regarding one or more tasks, etc.

Coordinating the educational and administrative activities of a school is complex and requires effective communication. In various embodiments, the tasking module of SIS 115 includes an automated alert module configured to send automated alerts and/or messages. In one embodiment, administrators use the automated alert module to format messages and deliver them to a targeted set of recipients. In one embodiment, students and parents access messages and send messages by accessing the functions of the automated alert module via PSP 195. Automated alerts may be system messages delivered to a user via a SIS 115 UI, email messages, text messages, short message service (SMS) messages or automated phone messages. Furthermore, automated alerts may be manually entered by a user or may be automatically generated by SIS 115. In one embodiment the automated alert module is configured to distribute messages to a targeted subset of users including a single user, a user role (e.g. all instructors), a class, a degree program, an academic department, an administrative department, a school, or all users associated with a standardized test.

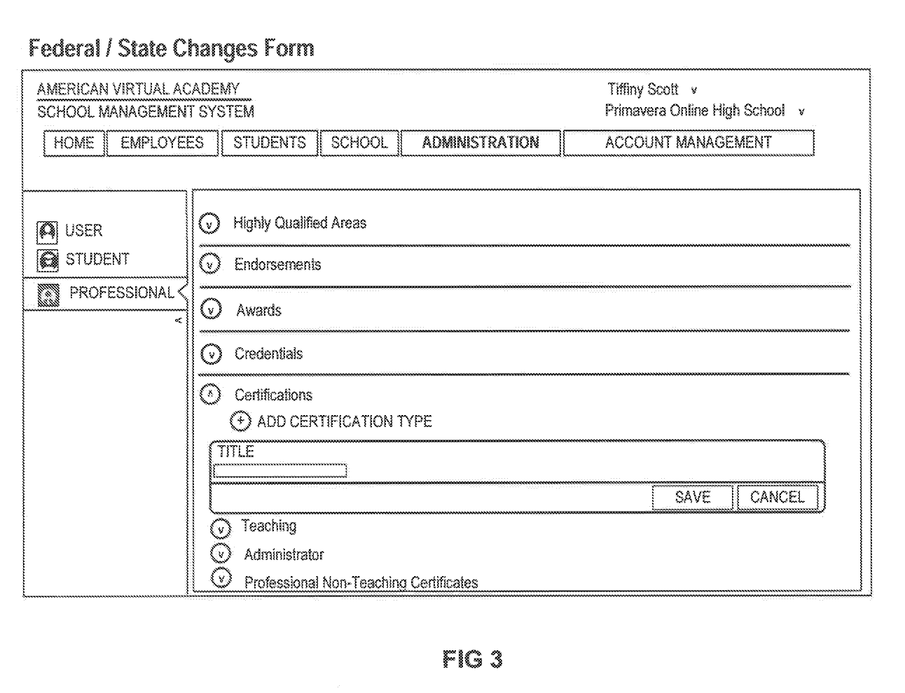

In various embodiments, SAM 175 includes functionality for enforcing course content requirements that may be mandated by, for example, an accreditation authority, a school board, a school district, a state government, the federal government, or an education industry standard. For example, FIG. 3 shows an exemplary a federal/state changes interface enables a user to change what specific data points are gathered and reported on or gathered per student, school, district or other.

In various embodiments, SAM 175 enables the definition, tracking, reporting and maintenance of organizational taxonomy relationships; such taxonomies may include, for example, school district taxonomies, school organizational charts, etc. Giving the ability to assign employees to supervisors, departments and working groups enables SIS 115 report on what the full organizational chart is for every school.

LMS 185 is a software subsystem in communication with SIS 115. In one embodiment, LMS 185 is configured to automate a plurality of learning management functions including course development, course management, course delivery, assessment creation, assessment delivery, and assessment evaluation. In various embodiments, LMS 185 may be an integrated component of SIS 115. In one embodiment, LMS 185 is “commercial off the shelf” software purchased from a vendor and configured to integrate with SIS 115 components, functions and data. Exemplary LMS 185's, comprise, but are not limited to a Course Management System (CMS), a Learning Content Management System (LCMS), a Managed Learning Environment (MLE), a Learning Support System (LSS), or a Learning Platform (LP) software system. In one embodiment, LMS 185 is connected to and in communication with PSP 195 and allows students to access all the educational material in LMS 185 via PSP 195. In one embodiment, CDR 150 stores data to populate the content of UIs and parameter data useful in dynamically configuring and/or customizing the UIs.

PSP 195 comprises software modules and UIs configured to provide user 105 (e.g., a parent or a student) access to the information and functionality of SIS 115. In one embodiment, PSP 195 includes a virtual class room, an online discussion UI, a messaging UI, an admissions UI, a course information UI, a guidance UI, a social networking UI, and a student portfolio UI. The data and form of the interfaces may be standardized or customized. In one embodiment, PSP 195 is a web portal and the data provided in the web portal is presented in customizable web parts. In one embodiment, the guidance UI comprises graduation progress data, transcript data, an academic status indicator, course scheduling data, standardized testing results, academic goals and achievements, career goals and achievements, post secondary goals and achievements, and extracurricular activity participation records, goals and achievements. In an embodiment, the admissions UI includes profile data, program of study data (e.g. diploma data), an admissions checklist, enrollment data for past, current and future academic sessions, resources and forms, and student documents and records. In one embodiment, the course information UI includes course expectation data, course syllabus data, gradebook data, attendance data, progress indicators, communication or messaging data, instructor data, assignment data, and access to the virtual classroom. In one embodiment the social networking UI comprises student yearbook, newsletter, literature magazine, blogs, and peer-to-peer communication and interaction. In one embodiment the knowledge center UI includes a course catalog, FAQs, a student handbook, course expectations, tutorials, and student orientation information. In one embodiment the student portfolio UI includes accomplishments, post graduation plans, academic work samples, unofficial transcripts, course syllabi.

In addition to the components described above, system 100, SIS 115, SMM 165, SAM 175, LMS 185 and PSP 195 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

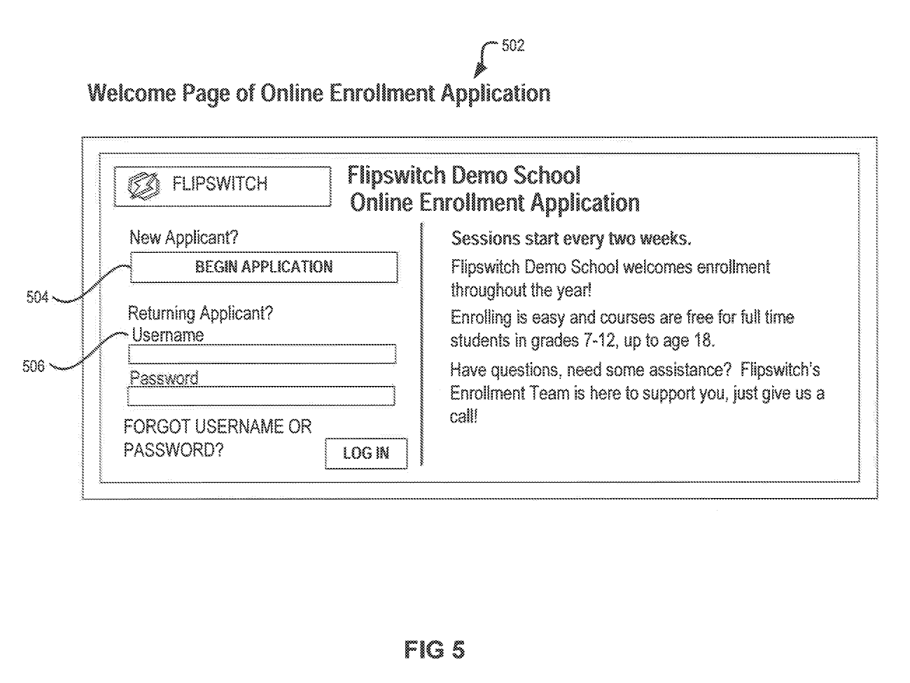

Therefore, in various embodiments, and with reference now to FIG. 5, the PSP 195 may display a UI or welcome page 502. The welcome page 502 may be displayed in response to a user “surfing to” or otherwise accessing the PSP 195, e.g., via a client 110. As described, a user may access the PSP 195 to enroll or register in an online school, login to an existing user account, and the like. In various embodiments, the welcome page 502 may present an option 504 to begin a new application and/or an option 506 to login as a returning applicant. The PSP 195 may, in response to registration or enrollment by a student, automatically generate a task requiring a teacher, as described herein, to make contact with the student. As described above, users such as students and/or parents may login to PSP 195 to monitor user progress and the like.

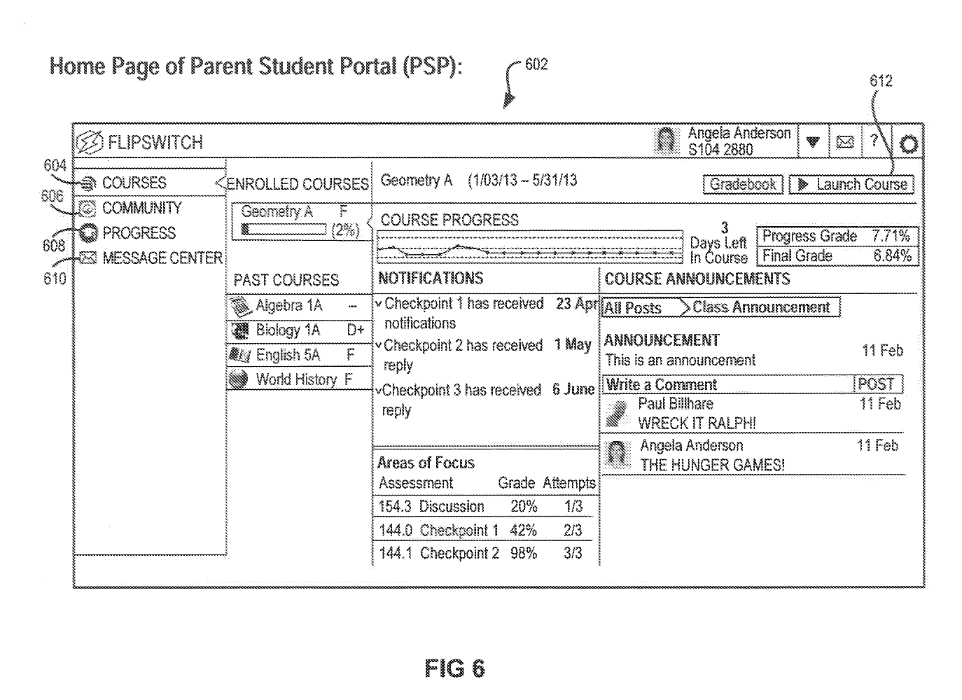

With reference to FIG. 6, a PSP 195 UI or home page 602 is displayed. The home page 602 may be displayed in response to account creation and/or login at page 502. In various embodiments, any data entered via the PSP 195 (e.g., including via the home page 602 and/or via any UI or option made available through the welcome page 502, the home page 602, and/or any other page or UI presented to or incorporated in the PSP 195) may be received and stored by the CDR 150. In addition, any data entered by a user via PSP 195 may be stored to the CDR 150 real-time (e.g., it may not be necessary for a user to select an option to submit data the user has entered in a form to upload and store the data to the CDR 150).

Further, in various embodiments, and as described above, the data collected (or sought to be collected) by the PSP 195 may be customizable according to a particular education provider's specifications. For example, an education provider (such as an online school) may customize one or more questions, options, and the like presented to users during an enrollment and/or login process. The pages and/or UIs comprising or presented by the PSP 195 (e.g., during enrollment and/or in response to login) may be customized. Thus, for example, and with reference to the home page 602, any of the options, data collection options and query tools, questions, data presented, and the like may be customized. These data, questions, options, etc. may, in various embodiments, be customized by an account administrator (e.g., a third party software developer) at the education provider's request

However, as described above, these data, questions, options, etc. may in various embodiments be customized by the education provider itself. In other words, the education provider may not be required to request that a software developer (e.g., a third party software developer from whom the education provider obtains the PSP 195 and other system components) alter the software or otherwise adjust the UIs comprising and/or presented by the PSP 195. Rather, through an education provider initiated and controlled process (e.g., a drag and drop process), the education provider may alter the content, look, and feel of its UIs. In particular, an education provider may not only adjust or alter the data collected, but the position and location of the options, dialog boxes, text boxes and fields, images, and the like comprising the PSP 195 UIs. Thus, an education provider may quickly and easily (e.g., within only a few minutes) customize the look and feel of the UIs presented by its uniquely styled PSP 195. The PSP 195 (and/or, as described herein, the SIS 115 and/or the LMS 185) may therefore be customized to feel like it “belongs” to a particular education provider.

Accordingly, with continuing attention to FIG. 6, a PSP 195 home page or UI 602 may include a plurality of options. Although the home page 602 may be described in terms of each of these options, the descriptions provided below with respect to each option are merely for purposes of illustration. The functionality associated with each option may be implemented in any of a variety of ways and/or under any of a variety of options by the PSP 195. Thus the PSP 195 may include, for example, a “courses” option 604, a “community” option 606, a “progress” option 608, and/or a “message center” option 610. In various embodiments, the labels associated with options 604-610 may vary, although the functionality associated with each option, as described herein, may remain.

A courses option 604 may, in various embodiments, display one or more courses or classes associated with a user (e.g., the option 604 may display courses in which a user is currently enrolled, courses in which the user was previous enrolled, courses in which the user is enrolled for an upcoming term, courses remaining to complete a degree, etc.) Further, in various embodiments, a courses option 604 may display any information associated with one or more such courses. For example, a courses option 604 may display course grades, course progress (both in terms of progress over time as well as progress based upon assignments completed), one or more notifications associated with one or more courses, course announcements, student comments with respect to the course, course assignments, course examinations, areas of focus or areas of a course where focus may be desirable or needed, a number of attempts remaining to obtain an adequate or threshold grade or score on an assignment, and the like.

A community option 606 may, if selected, enable a UI that displays a variety of social features. For example, a community option 606 may permit users to discuss a course, post content related (or unrelated) to a course, upload biographical information, such as a photograph and/or hobbies, interests, other photos, and the like. Thus, a community option 606 may in general facilitate social interaction between users of the PSP 195.

A progress option 608 may, if selected, enable a UI displaying a variety of information or data associated with a user's progress through a course or courses. For example, a progress option 608 may display one or more courses needed for graduation, one or more courses that will meet or satisfy a particular course requirement. In addition, a progress option 608 may display a visual indicator (e.g., a graph or status indicator) of a user's progress towards graduation (e.g., as a percentage of a total number of courses completed, a number completed and a number needed for graduation, and the like). Further, in various embodiments, a progress option 608 may display a user's course schedule, including a current course schedule, a past course schedule, an upcoming course schedule, a suggested course schedule, and the like.

In various embodiments, a progress option 608 (and/or any other option 604, 606, and/or 610) may calculate and/or display a grade or score associated with a student. For example, in various embodiments, a student may be assigned (for purposes of illustration) twenty assignments toward course completion. The student's final grade may comprise an average or weighted average of the scores received for each of the twenty assignments. However, in various embodiments, a student's score may be time based. For instance, a student's score may comprise a percentage or ratio of the number of assignments that the student has been assigned and should have completed (based upon assignment due dates or deadlines) by a particular time during the course in proportion to a number of assignments that the student has actually completed by the particular time. Thus, for example, where a student has been assigned twenty assignments, all of which have passed their due dates, if the student has only completed ten of these assignments (even if the student has scored 100% on each of the ten completed assignments), the student's score may reflect a completion ratio of 50% (10 completed assignments divided by 20 total assignments due). Thus, the PSP 195 (and/or the LMS 185 and/or the SIS 115) may measure a student's progress in terms of assignments completed, rather than (or in addition to) in terms of the student's score or performance with respect to each completed assignment.

The PSP 195, LMS 185, and/or SIS 115 may, in various embodiments, suggest a course schedule based upon one or more of the courses needed by a user for graduation, one or more parameters input by a user (e.g., interest, availability by day and/or time of day, etc.), one or more parameters defined by the PSP 195, LMS 185, and/or SIS 115, such as for example, that one or more courses overlap as to date and time (and so may not be scheduled together), that one or more courses are scheduled such that no large gaps in time exist between the ending time of a first course and the starting time of a second course (and so a user's time may be optimized, as the user may go immediately from one class to the next), and the like.

In various embodiments, a UI associated with the progress option 608 may be filterable. For instance, a user may choose to filter on any of a variety of criteria. More particularly, and to illustrate, a user may filter to display only completed courses, courses the user is currently enrolled in, courses the user must take in order to graduate, courses in which the user received a particular grade, courses having to do with a particular subject or subject area, courses taken during a particular time period, courses taught by a particular instructor, and the like. A progress option 608 may further display one or more assignments and/or tests/examinations, the results or scores associated with one or more assignments and/or examinations, and the like.

A message center option 610 may, if selected, display a UI associated with one or more notifications or messages. For example, a message center option 610 may display a UI that enables communications between users (e.g., between parents and students, between teachers and students, between parents and teachers, and the like). Thus, in various embodiments, a message center option 610 may function in a manner similar to email. For instance, a parent, student, and/or teacher may select the message center option 610 from the PSP 195 UI 602 to access an email system and/or another messaging system. A message center option 610 may further notify a user of a variety of events. For example, a message center option 610 may notify a user if a particular grade associated with the user drops below a threshold value. In addition, in various embodiments, a user may select an option to receive an automatically generated message in response to a variety of events. For instance, a user may request the delivery via the message center option 610 in response to a particular assignment or test score and/or in response to an overall class score exceeding or falling below a threshold score.

In various embodiments, a user may select an option, from the PSP 195 UI 602 to launch or enable an LMS 185. For example, with reference to FIG. 6, a user may select a “Launch Course” option 612 to launch the LMS 185. However, in various embodiments, a user may launch the LMS 185 from anywhere within the PSP 195 UI 602 and/or using any of a variety of selection options (e.g., buttons, radio switches, toggle switches, and the like). Further, in various embodiments, the LMS 185 may store and retrieve any and/or all data from a CDR 150. Thus, the CDR 150 may store all student date, and a PSP 195, LMS 185, and/or SIS 115 (as described herein) may access the CDR 150 to receive and/or store all data, such as parent data, student data, teacher data, education provider data, government and/or regulatory data, and the like.

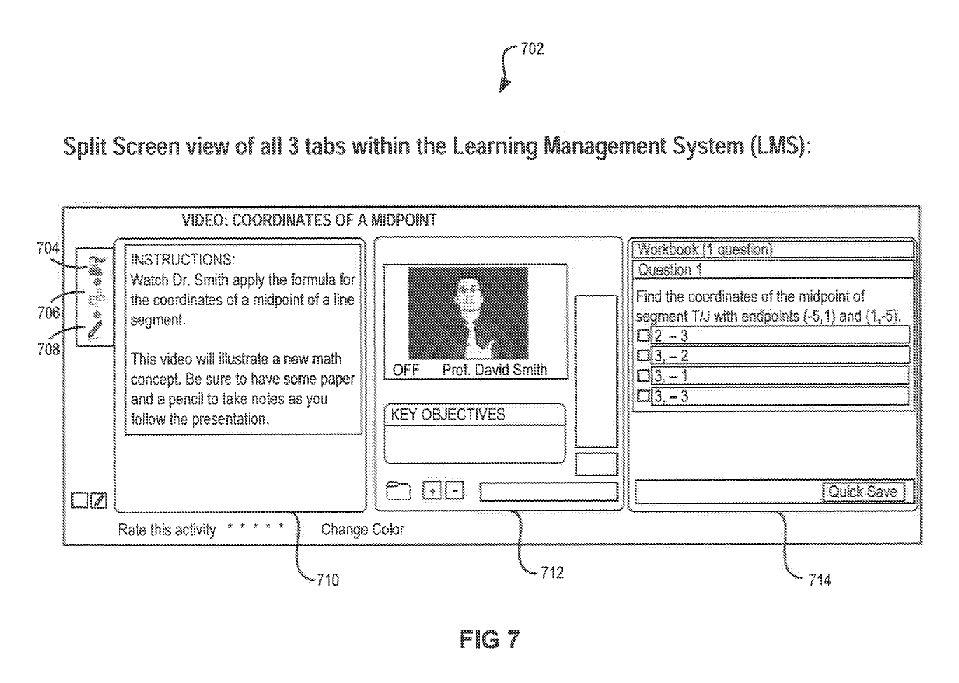

Therefore, as shown with respect to FIG. 7, an LMS 185 home page or UI 702 may be displayed in response to selection by a user of an option 612 to launch the LMS 185. The UI 702 may be accessible by a user, such as a student of an education provider. In various embodiments, the UI 702 may comprise one or more options, e.g., options 704, 706, and/or 708. Although the UI 702 may be described in terms of each of these options 704-708, the descriptions provided below with respect to each tab are merely for purposes of illustration. The functionality associated with each option 704-708 may be implemented in any of a variety of ways and/or under any of a variety of options or tabs by the LMS 185.

The option 704 may, for example, comprise an “instructions” option, which, if selected, may permit a student to access instructions related to a particular assignment and/or any other task. In various embodiments, the option 706 may comprise a “content” option, which, if selected, may permit a student to access online content related to a particular assignment and/or any other task. Similarly, in various embodiments, the option 708 may comprise a “workbook” option, which, if selected, may permit a student to access a workbook comprising one or more assignments and/or one or more questions or tasks associated with a particular assignment and/or any other task.

Thus, as shown, the instructions option 704 may be associated with an instructions dialog box 710. Further, if selected, the instructions option 704 may cause the LMS 185 to display the instructions dialog box 710. The instructions dialog box 710 may provide instructions to a student in relation to a particular assignment or task.

Similarly, the content option 706 may be associated with a content dialog box 712. Further, if selected, the content option 706 may cause the LMS 185 to display the content dialog box 712. The content dialog box 712 may provide content (e.g., educational materials) to a student in relation to a particular assignment or task.

Likewise, the workbook option 708 may be associated with a workbook dialog box 714. Further, if selected, the workbook option 708 may cause the LMS 185 to display the workbook dialog box 714. The workbook dialog box 714 may provide a workbook comprising one or more questions, tasks, assignments, activities, and the like to a student in relation to a particular assignment or task.

Thus, the LMS 185 may comprise a plurality of dialog boxes 710-714, each of which may relate to a particular assignment. For example, a student may initially read a set of instructions via the instructions dialog box 710. Having read these instructions, the student may move on to the content dialog box 712, where the student may receive and review educational materials related to an assignment or task. Thereafter, the student may apply what the student has learned through the educational materials to one or more questions or other tasks presented by the workbook dialog box 714.

In various embodiments, one or more questions presented within the workbook dialog box 714 may be intended to verify that a student has reviewed the content presented within the content dialog box 712. For example, one or more questions may not be intended to test a student's learning and/or ability to apply what the student has learned from the content presented within the content dialog box 712 (as other more conventional testing systems may do). Rather, the workbook dialog box 714 may present one or more questions simply to verify that a student has accessed and/or reviewed the content presented by the content dialog box 712. For example, where the content presented within the content dialog box 712 comprises an educational video taught by an instructor, a question presented within the workbook dialog box 714 may simply request that a student indicate the color of the presenter's tie, the presenter's gender (male or female), a hair color of the presenter, and the like.

Thus, the LMS 185 may verify that a student has attended to a particular assignment (irrespective of what the student leamed from the assignment). The LMS 185 may, in other words (and/or together with the PSP 195 and/or the SIS 115), keep and track student attendance. Where the LMS 185, the PSP 195, and/or the SIS 115 (or an instructor utilizing any of these) determines that a student is not attending courses/assignments and/or is only attending sporadically or irregularly, the instructor may, in various embodiments, contact the student to aid the student.

In various embodiments, each of the dialog boxes 710-714 may be displayed by the LMS 185 individually. That is, a dialog box 710-714 may not be displayed in juxtaposition to any other dialog box 710-714. However, in various embodiments, each of the dialog boxes 710-714 may be variously displayed in juxtaposition (e.g., simultaneously or contemporaneously) with any or all of the other dialog boxes 710-714. Thus, as shown at FIG. 7, each of the dialog boxes 710-714 may be displayed concurrently with each other. In this manner, a student may have access to instructions and content as the student completes an assignment presented within the workbook dialog box 714.

Further, in various embodiments, the LMS 185 (and/or the SIS 115 and/or PSP 195) may calculate and/or display an impact that completion (or non-completion) of one or more assignments may have on a student's total grade. For example, a student may request that the LMS 185 (and/or SIS 115 and/or PSP 195) calculate, in advance of completion and/or declining to complete an assignment, the impact that such an activity may have upon the student's overall grade. Thus, a student may use the system 100 to manage the student's time and resources to maximize the student's grade in light of these resources.

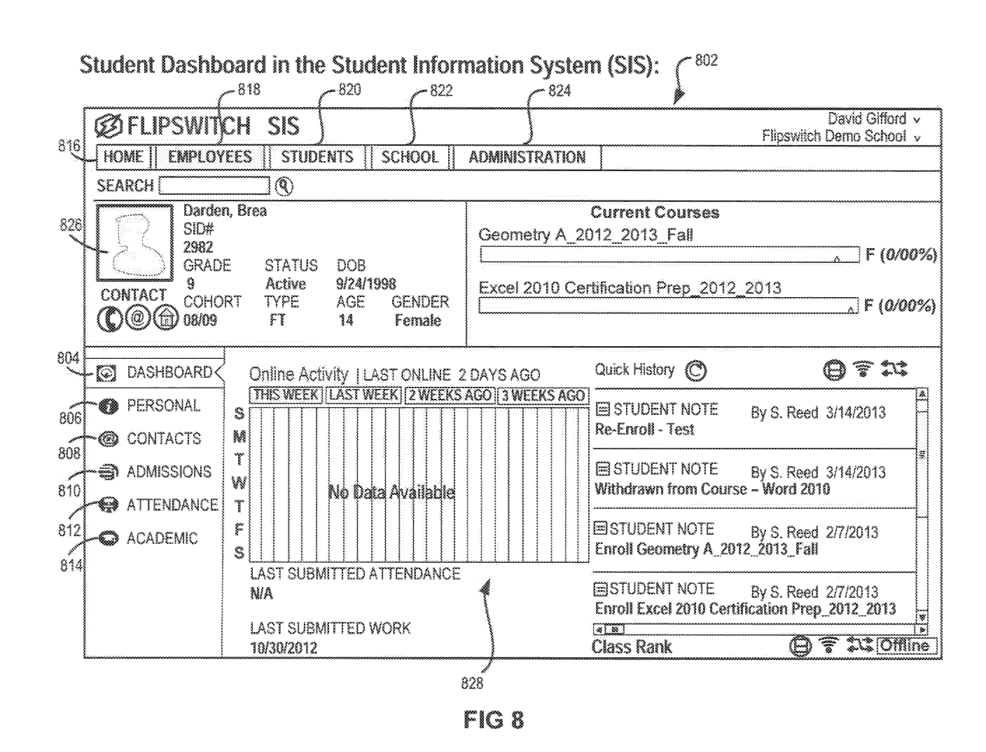

With attention now to FIG. 8, a SIS 115 UI 802 is shown. As shown, a SIS UI 802 may comprise, as described herein, an analytical models form (or “dashboard” 802), such as that shown at FIG. 4. Thus, FIG. 4 illustrates a SIS 115 UI or dashboard 402 as well. As described above, the SIS 115 may, like the PSP 195 and the LMS 185, receive any and/or all data from the CDR 150. Likewise, the SIS 115 may store any and/or all data to the CDR 150. Thus, the CDR 150 may comprise a centralized database from which all of the PSP 195, the LMS 185, and the SIS 115 request and/or receive data. Similarly, each of the PSP 195, the LMS 185, and the SIS 115 may store data to the CDR 150, thereby establishing the CDR 150 as a central data source common to each system 115, 185, and 195.

In addition, as shown, a dashboard 802 may comprise a variety of options 804, 806, 808, 810, 812, and/or 814 each of which may give access to a different data set and/or each of which may manipulate and/or analyze data in a unique manner. A dashboard 802 may further comprise, in various embodiments, one or more additional options 816, 818, 820, 822, and/or 824. Although the dashboard 802 may be described in terms of each of these options 804-824, the descriptions provided below with respect to each option are merely for purposes of illustration. The functionality associated with each option 804-824 may be implemented in any of a variety of ways and/or under any of a variety of options or options by the SIS 115.

Thus, in various embodiments, a “dashboard” option 804 may, for example, give access to a summary view of a particular student's progress and/or activity. In various embodiments, a dashboard is shown with respect to FIGS. 4 and 8.

Further, an option 818, which may be labeled, in various embodiments, “Employees” and which may be referred herein as an employees option 818 may, if selected, enable a display comprising a teacher's employee information. For instance, under an employees option 818, the SIS 115 may display a teacher's (or another employee's) credentials (e.g., teaching credentials), courses that an employee is qualified to teach, a department associated with the teacher, a teacher name, a teacher biography, a teacher schedule and/or office hours, teacher contact information, and the like.

Further, in various embodiments, the SIS 115 may display a general summary 826 comprising general information associated with a student as well as a detailed summary 828 comprising more detailed information associated with a student. In addition, the general summary 826 may be configured to minimize or “roll up” as a user scrolls down to review the detailed summary 828. This feature may permit a user, such as a teacher or account manager, to review a student's general information quickly before scrolling down to review more detailed information, as for example, where the account manager requires quick access to more detailed information. This may be useful, for example, where a teacher or account manager is on the telephone or otherwise corresponding real time with a student or parent.

In various embodiments, and as depicted at FIG. 4, the SIS 115 dashboard 402 and/or 802 may display information about a student's or parent's online activity. For example, the SIS 115 may display a graph 404 and/or any other representation of a user's online activity during a period of time. A user, such as a teacher or account manager, may utilize this information to determine a time that may be best suited to contact a user. For example, an account manager may wish to contact a user during a time that the information presented by the SIS 115 suggests the user has traditionally or historically logged into the SIS 115, the PSP 195 and/or the LMS 185.

Further, the SIS 115 (and/or the LMS 185 and/or the PSP 195) may track a student's grade point average over time. Where one of these systems determines that the student's grade point average has decreased or fallen below a particular average or threshold value, a user, such as the student, parent, and/or teacher may be automatically notified.

Further, the SIS 115 may include an option to request student records from a brick and mortar school and/or another online school previously attended by a particular student. In addition, one or more smart forms, as described herein, may enable auto-completion of certain data as a user enters the data. For example, where a first user enters a class from a student transcript, if a particular class has been previously entered by second user (e.g., algebra A1), as the first user begins to enter this course, the SIS may autocomplete the entry for the first user.

In various embodiments, SIS 115 may include a feature whereby a teacher may grant one or more roles or permissions associated with the teacher to a substitute teacher. Thus feature may, in various embodiments, be referred to as an “impersonate” feature and, in various embodiments, this feature may be accessible via the employees option 818. Using the impersonate feature, a substitute teacher may gain access to a teacher's lesson plans, student records, notes, and the like. In addition, a substitute teacher may use the impersonate option to alter or adjust course content, lesson plans, grades, student records, notes, and the like. However, where a substitute teacher makes changes in the SIS 115, these changes may be marked or flagged as made by the substitute teacher. Thus, the SIS 115 may track which teacher, the substitute teacher or the non-substitute teacher, makes changes as well as which changes each teach has made and when each change was made.

Further, in various embodiments, a teacher may utilize the SIS 115 to add notes (e.g., teacher notes) and/or other content and/or materials to a particular course and/or assignment. For instance, a teacher may add video content, link to a website (e.g., a teaching website), and the like using the SIS 115. In addition, in various embodiments, a teacher, like a student, may view a list of tasks associated with the teacher. Tasks may include assignments to be graded, documents to be submitted, assignments already graded, documents already submitted, and the like. In various embodiments, the SIS 115 may associate a variety of flags and/or alerts with a student. A flag may comprise a static, or permanent, data point, while an alert may comprise a dynamic, or temporary, data point. For example, a student may be associated with a flag indicating a peanut allergy, while a student may be associated with an alert indicating a grade point average that has fallen below a threshold value.

Further, as described herein, a third party may customize a PSP 195, an LMS 185, and/or the SIS 115 for an education provider. In various embodiments, the education provider may customize one or more of the PSP 195, an LMS 185, and/or the SIS 115 without the assistance of a third party software developer (e.g., the PSP 195, an LMS 185, and/or the SIS 115 developer). However, in various embodiments, the PSP 195, an LMS 185, and/or the SIS 115 developer may customize one or more of the PSP 195, an LMS 185, and/or the SIS 115 as well. In various embodiments, this may be accomplished using option 824, labeled “Administration.” Similarly, where an education provider wishes to make changes to PSP 195, an LMS 185, and/or the SIS 115, the education provider may make these changes using the option 822 labeled “School.” An education provider may control, to name a few options and for purposes of illustration, whether the PSP 195, the LMS 185, and/or the SIS 115 may display graphics, where a student may post or upload photos to these systems, content and/or privacy settings, and the like.

A search or filtering option may, as described herein, be included under and/or in association with any of the options provided by the SIS 115, and these search or filtering options may permit a user to search or filter data based upon a large variety of criteria within the options presented by the SIS 115. Further, in various embodiments, the SIS 115 may transmit one or more messages, alerts, or notifications to one or more users returned by a search or filtering operation. For example, in various embodiments, the SIS may track the online activity of a user and/or recommend or determine, based upon a pattern of online activity determined from the tracking, an optimal or ideal date and/or time to contact the user.

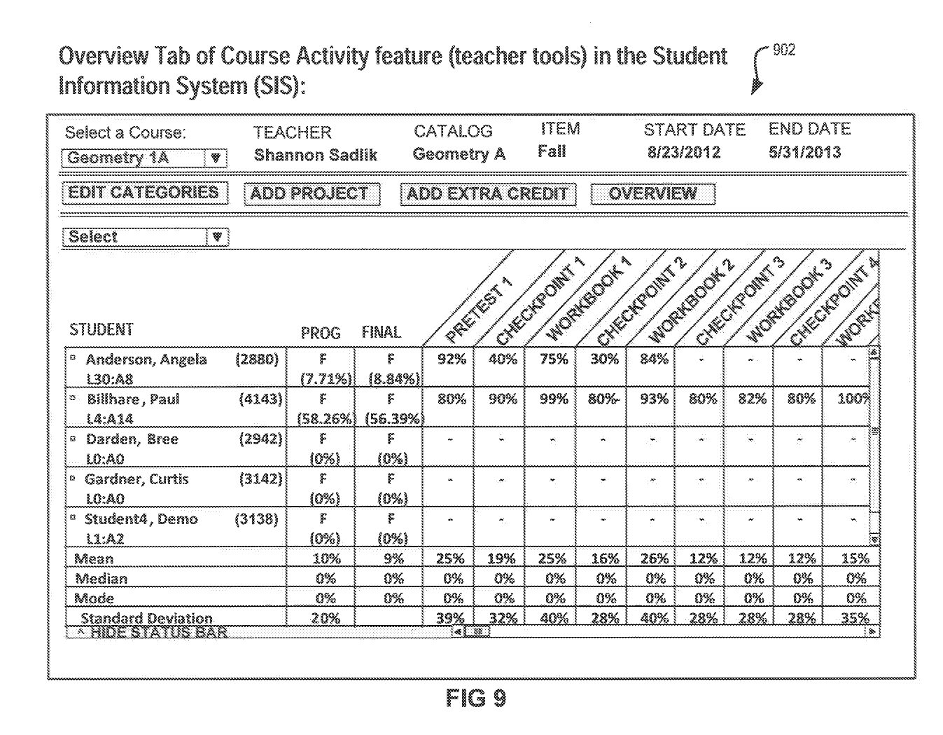

With brief reference to FIG. 9, a user (e.g., a teacher) may access a roster 902. The roster 902 may comprise an overview of activity for a selected course. Thus, an instructor may review scores for a plurality of students across a plurality of assignments for a particular course and the like. The roster 902 may be accessible from the SIS 115.

As will be appreciated by one of ordinary skill in the art, one or more system 100 components may be embodied as a customization of an existing system, an add-on product, upgraded software, a stand-alone system (e.g., kiosk), a distributed system, a method, a data processing system, a device for data processing, and/or a computer program product. Accordingly, individual system 100 components may take the form of an entirely software embodiment, an entirely hardware embodiment, or an embodiment combining aspects of both software and hardware. Furthermore, individual system 100 components may take the form of a computer-based system, a processor, computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Further, in various embodiments, the system 100 may comprise a computer-based system comprising an article of manufacture including a non-transitory, tangible computer readable medium having instructions stored thereon that, in response to execution by the computer-based system, cause the computer-based system to perform any of the operations and/or functionalities described herein.

Further still, in various embodiments, the system 100 may comprise a processor communicating with a tangible, non-transitory memory, wherein the tangible, non-transitory memory includes instructions stored thereon that, in response to execution by the processor, cause the processor to perform any of the operations and/or functionalities described herein.

Client 110 may include an operating system (e.g., Windows XP, Windows NT, 95/98/2000, XP, Vista, OS2, UNIX, Linux, Solaris, MacOS, Windows Mobile OS, Windows CE, Palm OS, Symbian OS, Blackberry OS, J2ME, etc.) as well as various conventional support software and drivers typically associated with mobile devices and/or computers. Client 110 may be in any environment with access to any network, including both wireless and wired network connections. In an embodiment, access is through a network or the Internet through a commercially available web-browser software package. Client 110 and SIS 115 components may be independently, separately or collectively suitably coupled to the network via data links which includes, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996). In an embodiment, any portion of client 110 is partially or fully connected to a network using a wired (“hard wire”) connection. As those skilled in the art will appreciate, client 110 and/or any of the system components may include wired and/or wireless portions.

Firewall 120, as used herein, may comprise any hardware and/or software suitably configured to protect SIS 115 components from users of other networks. Firewall 120 may reside in varying configurations including stateful inspection, proxy based and packet filtering, among others. Firewall 120 may be integrated as software within Internet server 125, any other system 100 component, or may reside within another computing device or may take the form of a standalone hardware component.

Internet server 125 may be configured to transmit data to client 110 within markup language documents. “Data” may include encompassing information such as commands, transaction requests, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Like Internet server 125, application server 145 may communicate with any number of other servers, databases and/or components through any means known in the art. Further, application server 145 may serve as a conduit between client 110 and the various systems and components of SIS 115. Internet server 125 may interface with application server 145 through any means known in the art including a LAN/WAN, for example. Application server 145 may further invoke software modules such as the SIS 115 in response to user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), Flash files or modules, FLEX, ActionScript, extensible markup language (XML), dynamic HTML, cascading style sheets (CSS), helper applications, plug-ins, and/or the like. A server may include a web service that receives a request from a web server, the request including a URL (e.g., http://yahoo.com/) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003).

FIG. 1 depicts databases that are included in an exemplary embodiment of the invention. An exemplary list of various databases used herein includes: an authentication database 135, a user database 140, CDR 150, external data sources 161 and/or other databases that aid in the functioning of the system. As practitioners will appreciate, while depicted as separate and/or independent entities for the purposes of illustration, databases residing within system 100 may represent multiple hardware, software, database, data structure and networking components. Furthermore, embodiments are not limited to the exemplary databases described herein, nor do embodiments necessarily utilize each of the disclosed exemplary databases.

Authentication database 135 may store information used in the authentication process such as, for example, user identifiers, passwords, access privileges, user preferences, user statistics, and the like. User database 140 maintains user information and credentials for SIS 115 users (e.g., user 105).

CDR 150 is a data repository that is configured to store a wide variety of comprehensive data for a virtual school. While depicted as a single logical entity in FIG. 1, those of skill in the art will appreciate that CDR 150 may, in some embodiments, consist of multiple physical and/or logical data sources. In one embodiment, CDR 150 stores demographic data, historical data, academic records, reporting data, audit records, predefined rules (e.g., a government requirement), process definitions (e.g., the admissions process), educational content, financial data, schedules, resource management data and the like.

External data source 161 represents databases and other data sources that are accessible by CDR 150 and other SIS 115 components. In one embodiment external data source 161 data may be provided by a school board, a school district, a state government, the federal government, the education industry, a vendor, etc. For example, in one embodiment, SIS 115 is configured to access a student's academic records from another school and integrate the data into a student information stored on CDR 150.

System 100 may be interconnected to external data source 161 (for example, to obtain data from a government entity, another school system, or a vendor) via a second network, referred to as the external gateway 163. The external gateway 163 may include any hardware and/or software suitably configured to facilitate communications and/or process transactions between system 100 and the external data source 161. Interconnection gateways are commercially available and known in the art. External gateway 163 may be implemented through commercially available hardware and/or software, through custom hardware and/or software components, or through a combination thereof. External gateway 163 may reside in a variety of configurations and may exist as a standalone system or may be a software component residing, for example, inside CDR 150, PSP 195, the external data source 161 or any other known configuration. External gateway 163 may be configured to deliver data directly to system 100 components (such as SIS 115) and to interact with other systems and components such as CDR 150 databases. In one embodiment, the external gateway 163 may comprise web services that are invoked to exchange data between the various disclosed systems. The external gateway 163 represents existing proprietary networks that presently accommodate data exchange for data such as financial transactions, customer demographics, billing transactions and the like. The external gateway 163 is a closed network that is assumed to be secure from eavesdroppers.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

One skilled in the art will also appreciate that, for security reasons, any databases, systems, devices, servers or other components of system 100 may consist of any combination thereof at a single location or at multiple locations, wherein each database or system includes any of various suitable security features, such as firewalls, access codes, encryption, decryption, compression, decompression, and/or the like.

The systems and methods may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, Flash, ActionScript, FLEX, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security Principles & Practice” by William Stallings, published by Prentice Hall.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

Referring now to the figures, the block system diagrams and process flow diagrams represent mere embodiments of the invention and are not intended to limit the scope of the invention as described herein. For example, steps recited in process flow diagrams may be executed in any order and are not limited to the order presented. It will be appreciated that the following description makes appropriate references not only to steps depicted in the figures, but also to the various system and interface components of the figures (e.g., as described above with reference to FIG. 1).

With reference again to FIG. 1, in one embodiment, when user 105 logs onto an application (e.g., SIS 115), Internet server 125 may invoke an application server 145. Application server 145 invokes logic in the SIS 115 by passing parameters relating to the user's 105 requests for data. The SIS 115 manages requests for data from the SIS 115 and communicates with system 100 components. Transmissions between user 105 and Internet server 125 may pass through a firewall 120 to help ensure the integrity of SIS 115 components. Practitioners will appreciate that the invention may incorporate any number of security schemes or none at all. In one embodiment, Internet server 125 receives page requests from client 110 and interacts with various other system 100 components to perform tasks related to requests from client 110.

Internet server 125 may invoke an authentication server 130 to verify the identity of user 105 and assign roles, access rights and/or permissions to user 105. In order to control access to the application server 145 or any other component of SIS 115, Internet server 125 may invoke an authentication server 130 in response to user 105 submissions of authentication credentials received at Internet server 125. When a request to access system 100 is received from Internet server 125, Internet server 125 determines if authentication is required and transmits a prompt to client 110. User 105 enters authentication data at client 110, which transmits the authentication data to Internet server 125. Internet server 125 passes the authentication data to authentication server which queries the user database 140 for corresponding credentials. When user 105 is authenticated, user 105 may access various applications and their corresponding data sources.

SIS 115 and CDR 150 may automate school functions and store data for multiple students, school districts and virtual schools. For example, SIS 115 may be configured for one virtual school or for all the schools in a school system or for a subset of schools in a state. While discussed herein in reference to an online education system such as a virtual school, in one embodiment, SIS 115, and its integrated components SMM 165, SAM 175, LMS 185 and PSP 195, may be implemented to automate processes, store data, manage resources, provide operational support and provide instruction for an existing “brick and mortar school.” That is, a virtual school implemented on SIS 115 may exist without the traditional physical structure (e.g., classrooms, offices, cafeteria, playground, etc.) and, in some embodiments, SIS 115 may be employed to enhance, and supplement and provide cost effective automation and educational services for an existing “brick and mortar school.”

In one embodiment, user 105 may be a school administrator who configures a new school by creating a school on SIS 115 or by modifying an existing school. User 105 may create and define virtual objects for the virtual school. User 105 may access logic and UI's within SIS 115 to create a virtual school on SIS 115 by manually entering data, by partially copying the attributes of an existing SIS 115 school, or by importing the attributes of an existing school from a file or from an external data source 161. User 105 may create other users and assign them roles (i.e., creating students, instructors, administrators, etc. as users in SIS 115). User 105 may create or modify a degree program, create or modify a course of instruction (“course”) and assign it to a degree program, associate content from LMS 185 with a course, assign students to a course, etc.

User 105 may also create or modify predefined rules (e.g., policy, rules, process steps, regulations, parameters, etc.) for a student, faculty member, class, curriculum, course of study, school or school system. Predefined rules are used by SIS 115, and specifically by SIS 115, to control, track, and make decisions within SIS 115. For instance, a predefined rule may set the length or duration of a school session (e.g., six weeks), set the minimum student age, set a maximum instructor to student ratio for classes, define Algebra and Geometry as prerequisites for a Calculus class, or specify standardized testing requirements mandated by government or regulatory authorities. User 105 chooses to create a new rule or selects an existing rule to update or modify. In one embodiment, student rules, processes and/or attributes may be copied from another student or may be imported via an automated process from an external data source 161 such as a state's education department's web site.

User 105 creates associations for the rules. For instance, user 105 may associate a rule with another school rule, a specific program, an academic discipline, a student, a group of students, a user role, a virtual school or a virtual school system. The school objects (e.g., users, roles, resources and rules) are stored on CDR 150 where they can be accessed by other SIS 115 components.

As previously discussed, CDR 150 is configured to store predefined rules. As one of skill in the art will appreciate, predefined rules for a virtual school may include rules determined by an accreditation authority, a school board, a school district, a state government, the federal government, an education industry standard, online privacy best practices, the date, a student location, a student type, a class type, the subject matter of a course, a degree type, the sex of a student, the age of a student, the race of a student, or the economic classification of a student. CDR 150 enables a virtual school to operate in an automated fashion. For instance, in one embodiment, guidance counselors accessing SMM 165 functionality may generate a list of recommended courses for a student based upon state requirements, based upon an assessment of a student's completion of prerequisites (i.e., implemented as a predefined rule) and/or based upon an operational factor such as balancing the load of registered students against available resources (e.g., only fill three calculus class for the current school session).

As previously disclosed, SMM 165 enables online, integrated and centralized management of the operations of a school. Predefined rules customized workflows, user roles and customized UI's enable administrators, managers, staff and instructors to manage the activities that support the educational process. For instance, in one embodiment SMM 165 includes an admissions module configured to automate the student admissions process. The admissions module for a virtual school in SIS 115 accesses CDR 150 and may access other SIS 115 components to dynamically create admissions forms (i.e., customized UI's) based upon the school admission's policies and other predefined rules. In one embodiment, an online application portal allows user 105 (e.g., a current or prospective student) to apply online for a class, a grouping of classes comprising a major or program or study, or any other educational product or service offered by an online education provider. The application portal enables students to enroll into the online educational system provider's classes by collecting the necessary data to enroll the student. The data collected at online application portal can be any information needed to enroll the student into a particular class or other program. In one embodiment, the data includes certain government required test scores, transcripts from other schools, or financial information to determine whether or not financial aid is available. The data may further comprise personal and/or demographic data about the student such as his address, telephone number, e-mail address, social security number, and a parent or guardian's contact information.

In a representative embodiment of an enrollment process enabled by SMM 165 a student accesses SIS 115 via an “app” and/or a webpage. In various embodiments, the app displays certain information needed from the student to complete enrollment. The amount and type of information requested varies depending on the online educational system provider and the type of classes or program the student enrolls in. According to this embodiment, information as to what the student can expect to happen next is also communicated to the student such as assignment of a unique login ID and password as well as class assignment. The information the student can provide is collected. The enrollment module of SMM 165 determines if the information entered is valid and is sufficient to complete enrollment. In one embodiment, SMM 165 accesses predefined rules stored on CDR 150 to determine if the appropriate type and quantity of information has been entered by a student by comparing the entered data with sets of data in CDR 150 to ensure that all data fields are populated with valid data. If the student has not provided valid or sufficient information, the admissions module triggers an event or sets a data flag such that SIS 115 will require an admissions staff member to follow up with the student. If the data is valid and sufficient, the admissions module executes appropriate logic and saves data to CDR 150 to enroll the student. In one embodiment, SIS 115 automatically provides the student with a unique user ID and login to provide the student access to other features of SIS 115.

In one embodiment, an admissions staff member (i.e., user 105 assigned to an admissions staff role) views admissions data on a UI. A listing of potential and enrolled students is shown and identified by a unique identification number. The UI also displays the status of each enrolled or potential student and the name of the admissions staff member or other staff that is working with that particular student. Certain students may be enrolled and need no action from admissions staff while other students are shown on the UI as being in the “screening” stage or the “document stage.” In this example, the document stage might indicate that additional documents are needed by admission staff and the particular staff member that is assigned to that potential student is also identified. Therefore, if the particular staff member assigned to obtain the documents has not done so with an appropriate time frame the workflow and scheduling functionality of SMM 165 will cause the UI to alert a different staff member. Thus, SIS 115 enables an online education provider to effectively manage staff and staff activities.

SIS 115 provides flexibility in defining processes, dynamically constructing UI's, and enforcing workflows so that differing processes can be implemented for various schools or depending on varying needs. For example, in an embodiment, the enrollment process discussed above may be substituted with an admissions and registration process whereby the student first must be admitted to a school or educational program and then enrolls in a particular session to receive instruction. The admissions module of SMM 165 admissions module may be configured to execute an admissions process that includes: receiving an application request; configuring an application form based at least partially on the content or form of the application request; receiving application data entered in the application for by a prospective student; storing the application data in CDR 150; sending an automated message to an admissions specialist, a guidance counselor or a school administrator; receiving at least one admissions response associated with the automated message; determining an admissions decision based at least partially upon the admissions response; and, informing the user of the admissions decision.

SMM 165 may also include a guidance module. Guidance staff (e.g., users 105 of SIS 115 assigned to the guidance staff role) utilize SMM 165 to perform activities associated with managing and advising students. In one embodiment, guidance staff may communicate with prospective students to obtain transcripts and schedule classes. In this regard, a guidance staff member accesses CDR 150 data (e.g., an e-mail address) and requests that the student send transcripts to the online education provider. In an embodiment, SMM 165 may be configured to allow guidance staff to communicate with other educational providers directly to obtain transcript and other needed information.

SMM 165 enables efficiency in an educational organization by providing task lists, workflow and customized interfaces that help optimize staff operations. Configurable, data driven and dynamic user interfaces allow each user, user role or administrative function to access relevant data and functions. For instance, in one embodiment guidance staff access an interface that lists students assigned to them, provides a log (e.g., an audit trail) of guidance related interactions with the student and provides access to student data and the student admissions and/or enrollment functions discussed previously. In an embodiment, instructors view a list of courses that they are assigned to and may view a listing of students, drill down to and edit gradebook entries for a particular student, access student assignments (e.g., by downloading files submitted by the student in the LMS), send messages to a student, recommend a student for counseling, send a message to a parent or guardian, etc.

SMM 165 also enables audit functions. An audit module may be configured to enable an auditor to monitor, track, analyze and report on activities and functions within SIS 115 such as instructor activity. In one embodiment the audit module allows a user 105 to set up predefined rules, events and thresholds and to track individual actions and store data on CDR 150. For instance, a regulatory requirement may mandate that an instructor participate in a school discussion by providing feedback and/or comment at a certain level or frequency (e.g., for every 5 entries made by students, instructor must provide an entry). The audit functionality provided by SMM 165 captures this information automatically and provides a mechanism for the auditor to view portal activity, such as an ongoing class discussion, without detection from other users.

SMM 165 also enables performance tracking functions. In addition to the previously described online discussion grading functions, in one embodiment SIS 115, via SMM 165, CDR 150 and PSP 195, provides a comprehensive, customizable and flexible performance tracking and reporting mechanism. The performance tracking module of SMM 165 automatically determines the performance tracking and reporting requirements for a student based upon a multitude of factors including predefined rules associated with federal requirements, state requirements, degree requirements, school requirements, the student's past performance, the student's current classes, etc. The performance module accesses CDR 150 data to assess student performance indicators such as the grade in a class, overall grade point average, grade point average in a particular academic discipline, standardized testing scores, grade trends, attendance indicators, attendance trends, etc. In one embodiment, the module determines when a performance report is required based upon a timeframe, the student performance indicators, performance tracking requirements, a student preference, a parent preference, or a guidance counselor preference. When a performance report is required, the module may generate and format a performance report and distribute it to a student, parent, guidance counselor, third-party system, the state government or the federal government. Furthermore, the performance tracking mechanism provides data and calculations to PSP 195 to present in the portal's progress tracking interface.

While the steps outlined above represent specific embodiments of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed.

The scope of the invention should be determined by the appended claims and their legal equivalents, rather than by the examples given above. Reference to an element in the singular is not intended to mean “one and only one” unless explicitly so stated, but rather “one or more.” Moreover, when a phrase similar to “at least one of A, B, or C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A method comprising:
receiving, by a computer-based system for providing online education, first data via a first user interface (“UI”) comprising a parent student portal (“PSP”);
receiving, by the computer-based system, second data via a second user interface (“UI”) comprising a learning management system (“LMS”);
receiving, by the computer-based system, third data via a third user interface (“UI”) comprising a student information system (“SIS”); and
storing, by the computer-based system, the first data, the second data, and the third data to a central data repository (“CDR”).

2. The method of claim 1, further comprising enabling, by the computer-based system, customization of at least one of the first UI, the second UI, and the third UI by an education provider.

3. The method of claim 1, further comprising:
filtering, by the computer-based system, data based upon a filter criterion; and
communicating, by the computer-based system, a notification to a plurality of users based upon the filtering.

4. The method of claim 1, further comprising:
tracking, by the computer-based system, the online activity of a user; and
determining, by the computer-based system, an optimal time to contact the user.

5. The method of claim 1, further comprising:
tracking, by the computer-based system, a grade point average of a user; and
communicating a notification in response to the tracking.

6. The method of claim 1, further comprising:
enabling, by the computer-based system, functionality whereby a substitute teacher impersonates and is provided access to the account of another teacher.

7. The method of claim 6, further comprising flagging, by the computer-based system, changes effected by the substitute teacher.

8. The method of claim 1, further comprising automatically requesting, by the computer-based system, student records from at least one of a brick and mortal education provider or an online education provider.

9. The method of claim 1, wherein the third UI comprises a general summary portion and a detailed summary portion, and wherein the general summary portion is capable of being minimized.

10. The method of claim 1, further comprising calculating, by the computer-based system and in advance of completion of an assignment, the impact that completion of the assignment will have upon an overall grade of a student.

11. The method of claim 1, further comprising calculating, by the computer-based system and in advance of non-completion of an assignment, the impact that non-completion of the assignment will have upon an overall grade of a student.

12. The method of claim 1, further comprising calculating, by the computer-based system, a grade of a student based upon a proportion of a number of assignments that a student has been assigned to complete by a particular time to a number of assignments that the student has actually completed by the particular time.

13. The method of claim 1, further comprising enabling, by the computer-based system, the addition of a resource by an instructor to a content dialog box displayed by the second UI.

14. The method of claim 1, further comprising displaying in juxtaposition, by the computer-based system and within the second UI, an instructions dialog box, a content dialog box, and a workbook dialog box.

15. The method of claim 14, whereby a student completes an assignment in the workbook dialog box.

16. The method of claim 1, further comprising associating, by the computer-based system, at least one of a temporary alert with a student and a permanent flag with a student.

17. The method of claim 1, further comprising displaying, by the computer-based system and within the third UI, Information associated with an instructor.

18. The method of claim 1, further comprising displaying, by the computer-based system and within the third UI, information associated with a student.

19. An article of manufacture including a non-transitory, tangible computer readable medium having instructions stored thereon that, in response to execution by a computer-based system for providing online education, cause the computer-based system to perform operations comprising:
receiving, by the computer-based system, first data via a first user interface (“UI”) comprising a parent student portal (“PSP”);
receiving, by the computer-based system, second data via a second user interface (“UI”) comprising a learning management system (“LMS”);
receiving, by the computer-based system, third data via a third user interface (“UI”) comprising a student information system (“SIS”); and
storing, by the computer-based system, the first data, the second data, and the third data to a central data repository (“CDR”), wherein the CDR is capable of being accessed by the PSP, the LMS, and the SIS.

20. The article of claim 19, wherein the first data comprises enrollment data, the second data comprises workbook data, and the third data comprises student data.

21. The article of claim 19, wherein the computer-based system implements a virtual school.

22. The article of claim 19, wherein at least one of the first UI, the second UI, and the third UI are capable of being customized by an education provider.

23. The article of claim 19, further comprising customizing, by the computer-based system, a diploma.

24. A system comprising:
a tangible, non-transitory memory communicating with a processor for providing online education,
the tangible, non-transitory memory having instructions stored thereon that, in response to execution by the processor, cause the processor to perform operations comprising:
receiving, by the processor, first data via a first user interface (“UI”) comprising a parent student portal (“PSP”);
receiving, by the processor, second data via a second user interface (“UI”) comprising a learning management system (“LMS”);
receiving, by the processor, third data via a third user interface (“UI”) comprising a student information system (“SIS”); and
storing, by the processor, the first data, the second data, and the third data to a central data repository (“CDR”).

25. The system of claim 24, wherein the first data comprises enrollment data, the second data comprises workbook data, and the third data comprises student data.

26. The system of claim 24, wherein the processor implements a virtual school.

27. The system of claim 24, wherein at least one of the first UI, the second UI, and the third UI are capable of being customized by an education provider.

28. The system of claim 24, further comprising customizing, by the processor, a diploma.
